(19) United States
(12) Patent Application Publication
(10) Pub. No.: US 2015/0253758 A1
(43) Pub. Date: Sep. 10, 2015

(54) NUMERICAL CONTROL DEVICE

(71) Applicant: FANUC Corporation, Minamitsuru-gun (JP)

(72) Inventor: Noriaki HATANAKA, Minamitsuru-gun (JP)

(21) Appl. No.: 14/640,433

(22) Filed: Mar. 6, 2015

(30) Foreign Application Priority Data
Mar. 7, 2014 (JP) 2014-045369

(51) Int. Cl. G05B 19/406

(52) U.S. Cl. CPC G05B 19/406; G05B 2219/31439; G05B 2219/34015

(57) ABSTRACT

A program axis command checking unit belonging to a directed program analyzing unit determines whether or not there is a command of a target axis of an erroneous axis command in a directed program and whether or not a directed value exceeds an allowable range, and an interpolation axis command checking unit belonging to an interpolation command generating unit determines whether or not there is a command of a target axis of an erroneous axis command and whether a directed value exceeds an allowable range, and performs alarm stop by making an alarm stop request in a case where the alarm stop is to be performed.

### BACKGROUND OF THE INVENTION

1. Field of the Invention

The present invention relates to a numerical control device that detects an erroneous axis command. While numerical control devices control machine tools, particularly, an erroneous operation of an axis in a machine tool frequently causes a significant result such as erroneous cutting or machine damage. Thus, the present invention prevents such an erroneous operation, particularly, by detecting an erroneous axis command.

2. Description of the Related Art

In Japanese Patent Application Laid-Open No. 5-143130, a numerical control device has been disclosed, which stores reading/writing permission information for each variable and generates an alarm when a reading/writing operation is determined not to be permitted for a desired machining system.

In addition, in Japanese Patent Application Laid-Open No. 2003-295916, a numerical control device has been disclosed, which determines whether or not a numerical value that is newly input for an item satisfies a condition acquired by combining an average and a standard deviation of numerical values set for the same item in the past and displays an indication in a case where the condition is not satisfied.

### <Macro Call>

A macro is a program in which a certain fixed operation or a repeatedly-performed operation is registered, and, by using a macro call, a program can be described in a simple manner. In addition, by designating arguments or performing multiple calls at the time of performing a macro call, a call having higher versatility can be realized.

However, when a complex call relation is directed, the program becomes complicated, and there are cases where an erroneous command is caused. An example of such a program is illustrated in FIG. 1. As illustrated in FIG. 1, in O0001, when moving commands of X, Y, and Z are given using arguments A, B, and C, the arguments become variables #1, #2, and #3 of a macro program O9010, the position is determined as N11 by adding shift amounts (100.0, 200.0, and 150.0) respectively to #1, #2, and #3, the process is returned to the original program, and machining is performed. Here, adding operations are performed by using common variables #101, #102, and #103. In O0002, when moving commands of X and Y are given using arguments A and B, the arguments become variables #1 and #2 of a macro program O9010, and the positions of X and Y are determined as N11 by adding shift amounts (100.0 and 200.0) respectively to #1 and #2, the process is returned to the original program, and machining is intended to be performed.

Here, the macro program O9010 is a common macro program used for a moving command. However, since #103 is a common variable, the value of #103 according to the previous call remains, and a moving command of the Z axis that is not directed in O0002 is generated in N11. As above, when there is a call relation that is not simple, there are cases where a moving command for an axis for which moving is not intended is generated. In this example, while one-fold call has been described as an example, when the call is multiplexed to be complicated as being two-folded or three-folded, an unintended moving command may be generated easier.

### <Cutter Radius Compensation>

A cutter radius compensation is a function for designating a shape that is actually processed as a programmed path and offsetting a tool center point path by a radius of a tool used for machining. Accordingly, there is an advantage that the program does not need to be changed even when the diameter of the tool used for the machining is changed.

FIG. 2 is an example of a program for the cutter radius compensation on an XY plane according to a command G17. An offset vector is generated on the XY plane. However, as illustrated in FIG. 3, when the command G17 of N10 is erroneously directed as G19 (YZ plane), the offset vector is generated on a YZ plane, and an unintended operation of the Z axis is generated.

### <Tool Center Point Control>

A tool center point control is a control process for moving the center point of a tool along a directed path by performing a correction of a tool length every moment for every interpolation period also within a command block of a program. However, since the correction command of the tool length changes according to the moving of the rotation axis, there are cases where undirected moving of the axis occurs.

In FIG. 4, G43.4 is a tool center point control start G code. While there is no Z-axis command in a block N17, as illustrated in the figure, moving of the Z axis occurs at a machine position located on the tool base side according to a change in the B axis. Since the moving amount of the Z axis is based on the tool length offset, there are cases where the moving amount becomes a large moving amount that is not expected by an operator depending on the tool length offset.

The numerical control devices disclosed in Japanese Patent Application Laid-Open Nos. 5-143130 and 2003-295916 cannot detect an alarm by focusing on an axis command and cannot detect an erroneous axis command according to a macro call, a cutter radius compensation, a tool center point control, and the like.

### SUMMARY OF THE INVENTION

An object of the present invention is to provide a numerical control device that smoothly performs operation checking together with preventing an erroneous operation by performing alarm stop when an erroneous axis command according to a macro call, a cutter radius compensation, a tool center point control, and the like described above is detected.

A numerical control device according to the present invention including a directed program analyzing unit for analyzing a directed program, and an interpolation command generating unit for generating an interpolation command based on a result of the analysis by the directed program analyzing unit. The numerical control device includes: an alarm axis designating unit configured to designate an axis that becomes a criterion for an alarm; and an axis command checking unit configured to perform alarm stop in a case where the axis designated by the alarm axis designating unit is directed or the interpolation command generating unit interpolates the axis designated by the alarm axis designating unit as a result of the analysis of the directed program that is performed by the directed program analyzing unit.

The above-described axis command checking unit may belong to the directed program analyzing unit, and the axis command checking unit is configured to, determine whether or not the axis designated by the alarm axis designating unit is directed in the directed program and determine whether or not an amount directed for the axis exceeds an allowable range set in advance, and perform alarm stop in a case where the directed amount exceeds the allowable range.

The above-described axis command checking unit may belong to the interpolation command generating unit, and the axis command checking unit is configured to, determine whether or not the axis designated by the alarm axis designating unit is directed in the interpolation command and, in a case where an erroneous axis command is directed, determine whether or not a directed amount exceeds an allowable range set in advance, and, in a case where the directed amount exceeds the allowable range, perform alarm stop.

The above-described axis command checking unit may be configured to, determine whether or not the axis designated by the alarm axis designating unit is directed in the directed program analyzing unit and, in a case where the axis is directed, determine whether or not a directed amount exceeds an allowable range set in advance, and, in a case where the directed amount exceeds the allowable range, perform alarm stop, and further determine whether or not the axis designated by the alarm axis designating unit is directed in the interpolation command generating unit, and, in a case where the designated axis is directed, determine whether or not a directed amount exceeds an allowable range set in advance, and, in a case where the directed amount exceeds the allowable range, perform alarm stop.

The above-described the axis command checking unit may include a program axis command checking unit that determines whether or not the axis designated by the alarm axis designating unit is directed and determines whether or not a directed amount for the axis exceeds an allowable range set in advance and performs alarm stop in a case where the axis designated by the alarm axis designating unit is directed or in a case where the directed amount exceeds the allowable range.

The above-described interpolation command generating unit may include an interpolation axis command checking unit that determines whether or not the axis designated by the alarm axis designating unit is directed and whether or not an amount directed for the axis exceeds an allowable range set in advance and performs alarm stop in a case where the interpolation command generating unit gives a command of interpolation for the axis designated by the alarm axis designating unit or in a case where the directed amount exceeds the allowable range.

Alternatively, the above-described numerical control device may include the above-described program axis command checking unit and the above-described interpolation axis command checking unit.

By including the above-described configurations, the present invention performs alarm stop when an erroneous axis command according to a cutter radius compensation, a tool center point control, or the like is detected, thereby providing a numerical control device that smoothly performs operation checking together with preventing a malfunction.

### BRIEF DESCRIPTION OF THE DRAWINGS

The above and other features and advantages of the present invention will become more apparent by describing in detail exemplary embodiments as below with reference to the attached drawings in which:

FIG. 1 is a diagram that illustrates an example of a macro program;

FIG. 2 is a diagram that illustrates an example of a program of an XY-plane cutter radius compensation;

FIG. 3 is a diagram that illustrates an example of a program of a YZ plane cutter radius compensation;

FIG. 4 is a diagram that illustrates an example of a program of a tool center point control;

FIG. 5 is a diagram that illustrates an example of setting of an alarm detection condition;

FIG. 6 is a diagram that illustrates an example of detecting an alarm in a defined program command;

FIG. 7 is a diagram that illustrates an example of detecting an alarm in an axis command exceeding an allowable range;

FIG. 8 is a diagram that illustrates an example of a program of a tool center point control;

FIG. 9 is a block diagram of a numerical control device according to an embodiment of the present invention;

FIG. 10 is a flowchart that illustrates the process of a program axis command checking unit illustrated in FIG. 9; and

FIG. 11 is a flowchart that illustrates the process of an interpolation axis command checking unit illustrated in FIG. 9.

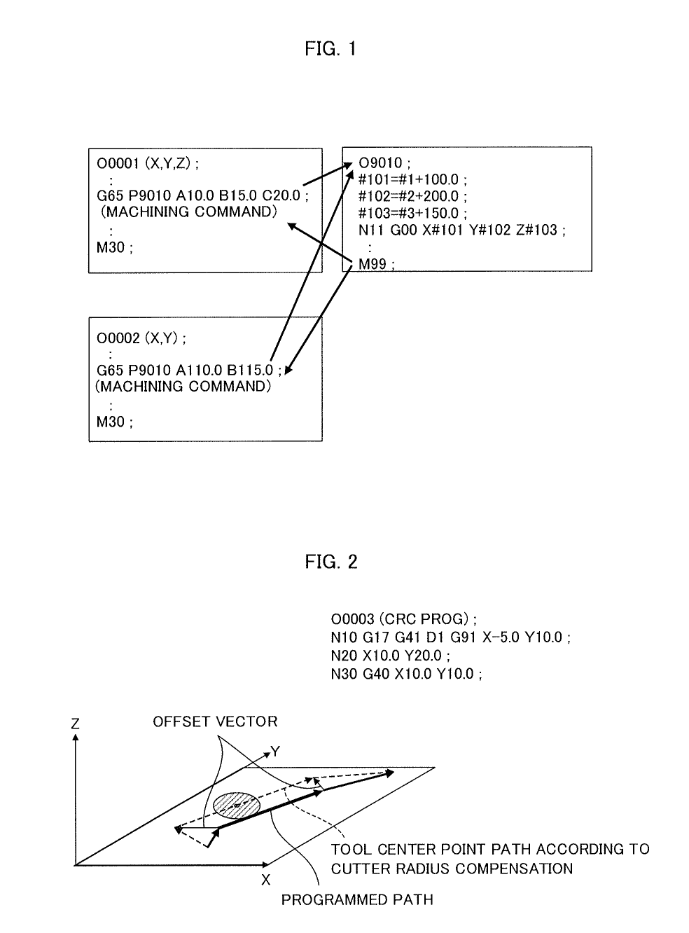

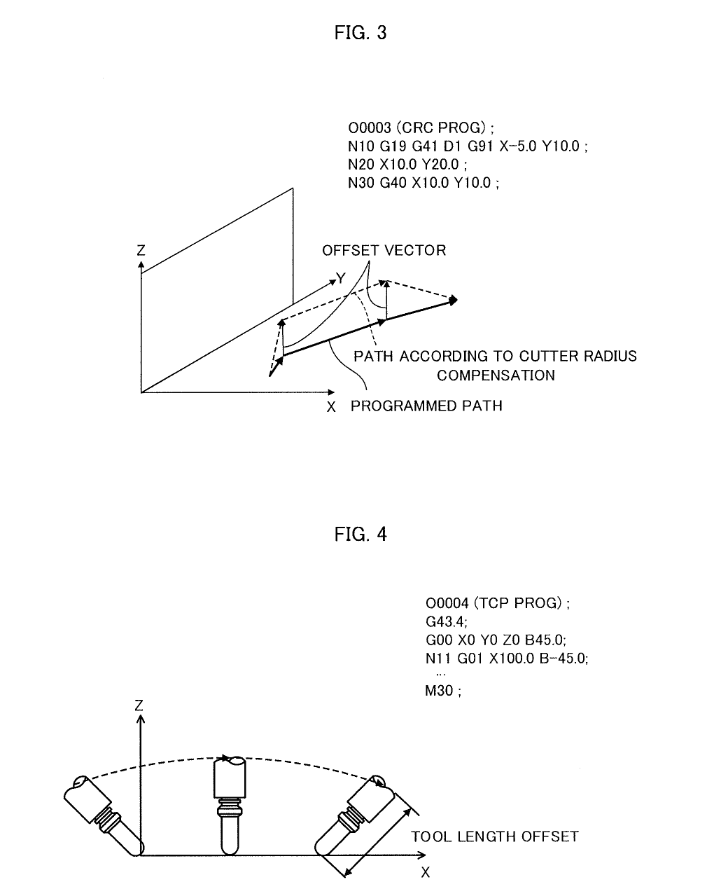

### DETAILED DESCRIPTION OF THE PREFERRED EMBODIMENTS

### Embodiment 1

According to Embodiment 1, an erroneous axis command is detected in a program.

As described above, in a case where a macro call is performed in a multiplexed manner, a program becomes complicated. Thus, a program axis command checking unit belonging to a directed program analyzing unit of the numerical control device performs a checking operation based on an alarm detection condition and performs alarm stop when an erroneous or unintended axis command is performed.

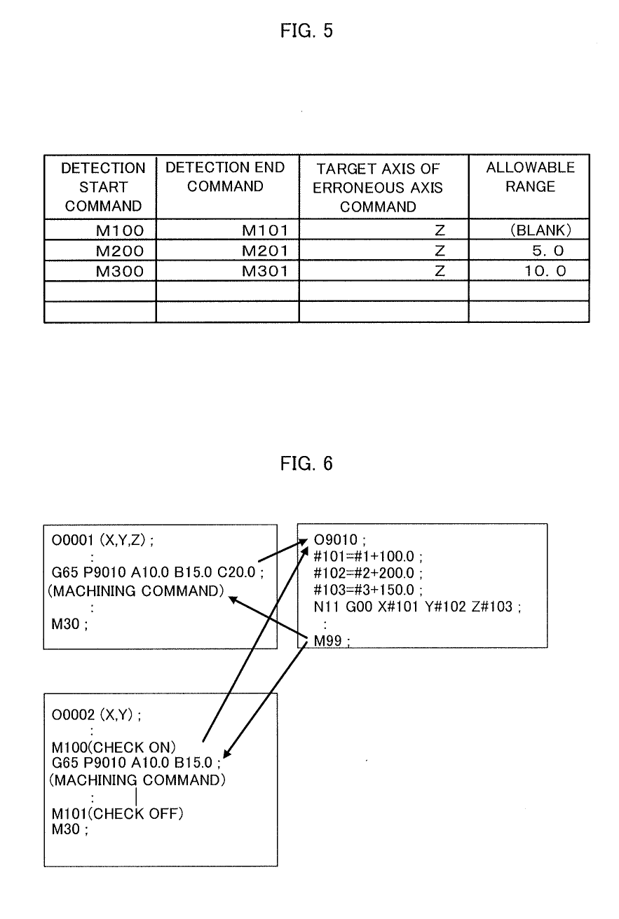

An example of a setting screen of an alarm detection condition that is set in advance is illustrated in FIG. 5. A setting item of the second row is a setting in which alarm stop is performed in a case where a Z axis is directed as a target axis of an erroneous axis command between a command M100 and a command M101 in a program command. The allowable range is blank, which represents a setting in which alarm stop is performed based on only the presence of the command. A setting item of the third row is a setting in which alarm stop is performed in the case of an axis command in which the moving amount of the Z axis that is a target axis of an erroneous axis command between a command M200 and a command M201 is more than 5.0 in a program command. Similarly, a setting item of the 4th row is a setting in which alarm stop is performed in the case of an axis command in which the Z axis moves more than 10.0 between a command M300 and a command M301. Here, while the detection start command and the detection end command are inputs using M codes, a target axis of an erroneous axis command is an input using a character, and an allowable range is an input using a numerical value, inputs using another code, a signal, and the like may be used.

Under the alarm detection condition set in FIG. 5, programs O0001 and O0002 illustrated in FIG. 6 are operated. Since there is an axis command of the Z axis between the command M100 and the command M101 of O0002, alarm stop is performed for the Z-axis command of N11 in O9010.

### Embodiment 2

According to Embodiment 2, an erroneous axis command exceeding an allowable range is detected in a program.

As described above, in a case where a program using a cutter radius compensation is generated, when a plane to be offset is erroneously designated, there are cases where moving of an axis that is not present in an intended plane occurs. A program axis command checking unit belonging to a directed program analyzing unit performs checking based on the alarm detection condition, and, when an erroneous (unintended) axis command is performed, alarm stop is performed.

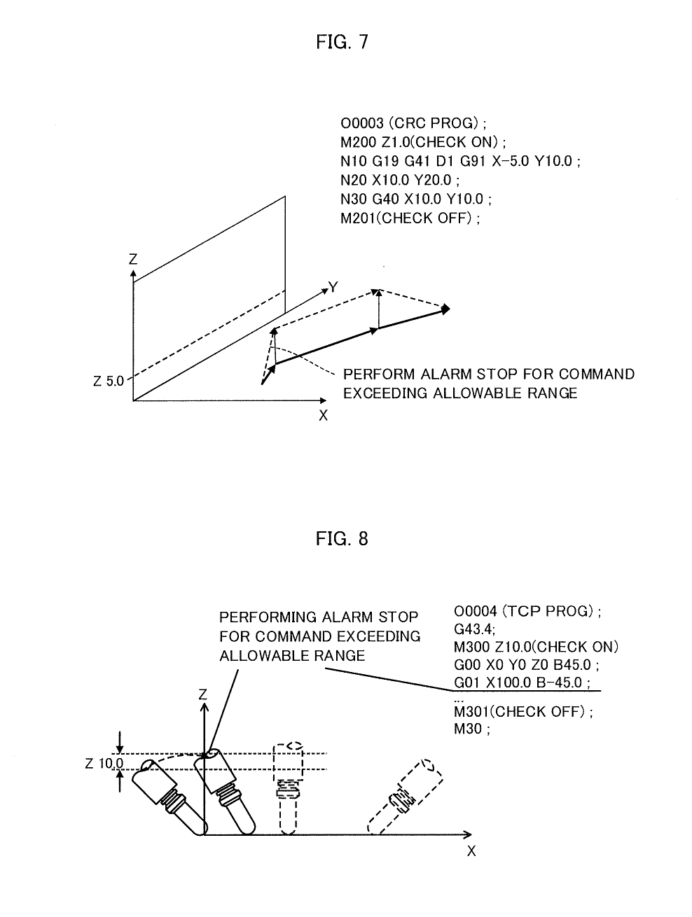

Under the alarm detection condition set in FIG. 5, a program O0003 illustrated in FIG. 7 is operated. In the case represented in FIG. 7, a program that is on the premise of a plane G17 is generated after N10. When this program is erroneously executed on a plane G19, a command of the Z-axis command that is not intended at the time of generating the program is generated.

In a block N10 positioned between a command M200 and a command M201 of O0003, since the Z axis is moved more than 5.0, alarm stop is performed in the block N10 of O0003. In addition, in this embodiment, an allowable amount represented in FIG. 5 is directed together with M200 also in the block N10. In this way, the allowable range may be directed in a program.

### Embodiment 3

According to Embodiment 3, an erroneous axis command exceeding an allowable range is detected in interpolation.

As described above, when a program including a moving command of a rotation axis is directed during the tool center point control, moving of the Z axis that is not directed occurs. An interpolation axis command checking unit belonging to an interpolation command generating unit performs checking based on the alarm detection condition and performs alarm stop when an erroneous (unintended) axis command is performed.

Under the alarm detection condition set in FIG. 5, a program O0004 illustrated in FIG. 8 is operated. In a command G01 positioned between a command M300 and a command M301 of O0004, since an axis command for moving of the Z axis more than 10.0 is generated, alarm stop is performed in a command G01 of O0004. In addition, in this example, the allowable range of 10.0 may be set as illustrated in FIG. 5 or may be directed in a command block of M300.

### <Block Diagram>

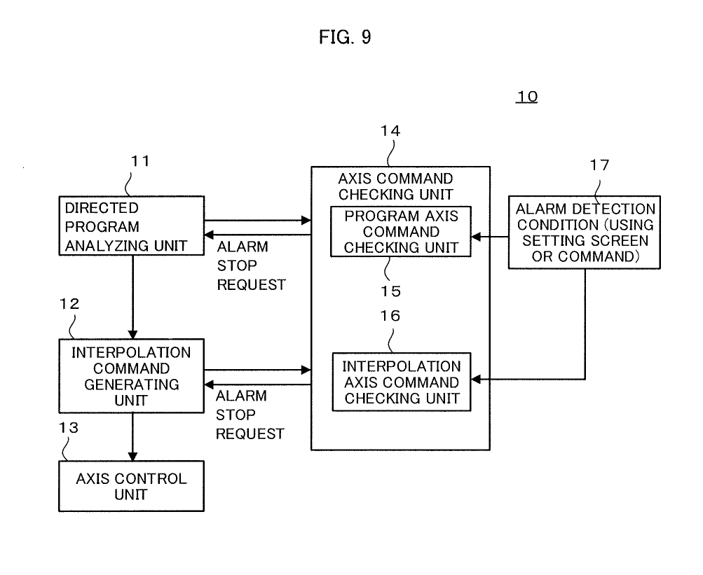

FIG. 9 illustrates a block diagram according to this embodiment. A numerical control device 10 analyzes a program that is directed by a directed program analyzing unit 11, generates an interpolation command based on the analyzed data by using an interpolation command generating unit 12, and transmits the generated interpolation command to an axis control unit 13. Then, the axis control unit 13 controls a tool machine by driving each axis motor of the tool machine.

In this embodiment, the program axis command checking unit 15 belonging to the directed program analyzing unit 11 determines whether or not there is a command of a target axis of an erroneous axis command that is an alarm detection condition in the directed program, and whether or not a directed value exceeds an allowable range. In addition, an interpolation axis command checking unit 16 belonging to an interpolation command generating unit 12 determines whether or not there is a command of a target axis of an erroneous axis command and whether or not the directed value exceeds the allowable range and performs alarm stop by making an alarm stop request in a case where the alarm stop is to be performed. The alarm stop request is made for the directed program analyzing unit 11 or the interpolation command generating unit 12. An axis command checking unit 14 is configured by at least one of a program axis command checking unit 15 and an interpolation axis command checking unit 16. In other words, in the case represented in FIG. 9, while the axis command checking unit 14 is configured by the program axis command checking unit and the interpolation axis command checking unit, it may be configured by any one thereof. An alarm axis designating unit 17 designates an axis that becomes a criterion for the alarm, and the designation is made by an input screen of the numerical control device 10 or a program.

### <Flowchart>

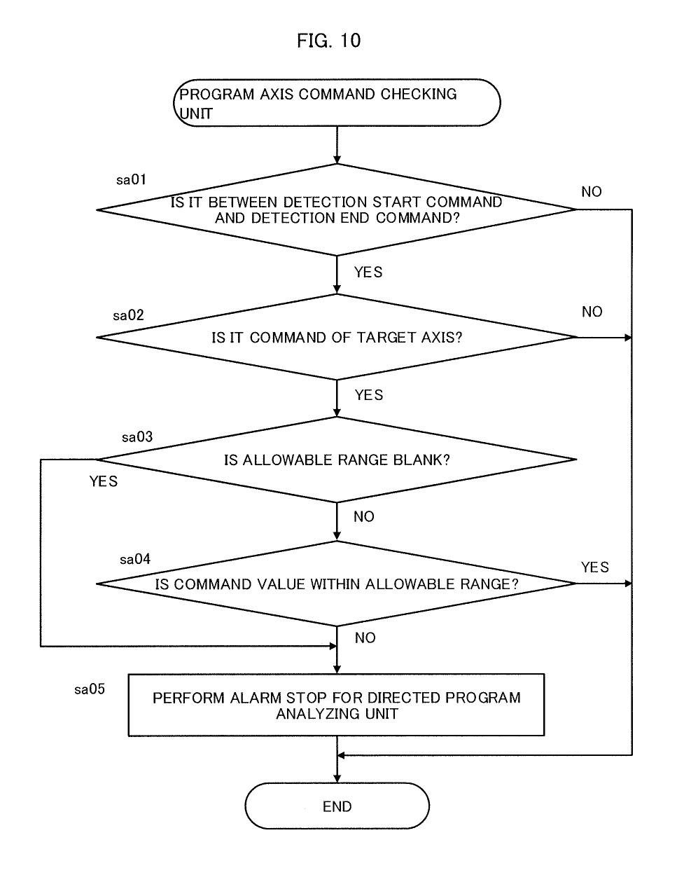

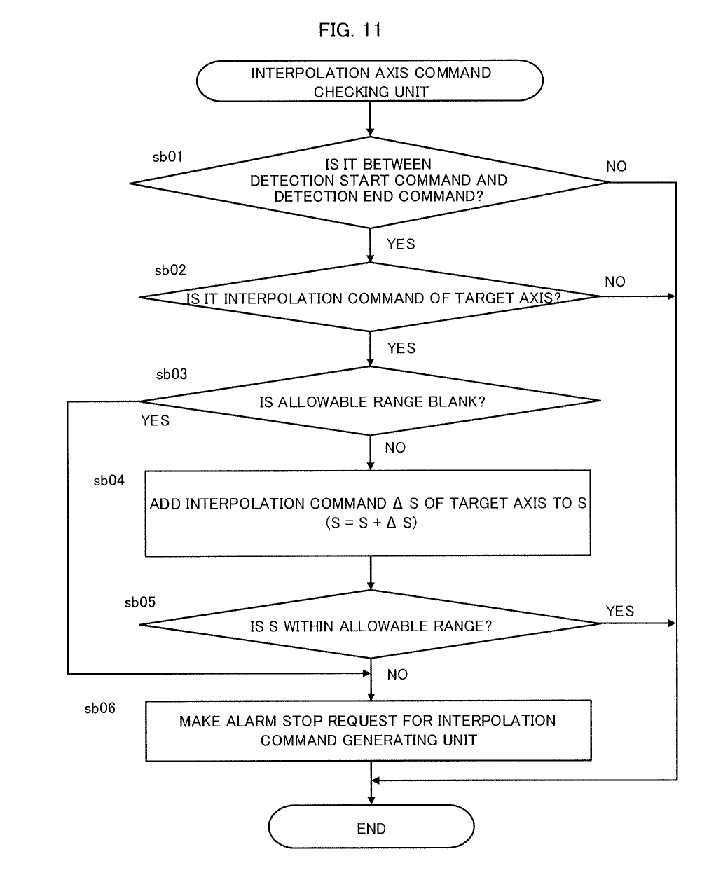

The processes of the program axis command checking unit 15 and the interpolation axis command checking unit 16 are respectively illustrated in FIGS. 10 and 11. The directed program analyzing unit 11 analyzes a directed program and generates a command value of each address for each block. The directed program analyzing unit 11 analyzes each block and calls the program axis command checking unit 15 for each generation of the command value of each axis. The interpolation command generating unit 12 generates an interpolation command of each axis for every interpolation period based on the analyzed data acquired by the directed program analyzing unit 11, thereby performing an interpolation process. The interpolation command generating unit 12 calls the interpolation axis command checking unit 16 for each generation of the interpolation command of each axis in each interpolation period. An interpolation command accumulated value S of the target axis of the interpolation axis command checking unit 16 is initialized to zero when a detection start command is made. An interpolation command of the target axis in the interpolation period is denoted as ΔS.

FIG. 10 is a flowchart that illustrates the process of the program axis command checking unit illustrated in FIG. 9. Hereinafter, each step will be described.

[Step sa01] Whether it is between the detection start command and the detection end command is determined, and, in the case of “Yes”, the process proceeds to Step sa02, and in the case of “No”, the process ends.
[Step sa02] It is determined whether or not the command is a command of the target axis, and, in the case of “Yes”, the process proceeds to Step sa03, and in the case of “No”, the process ends.
[Step sa03] It is determined whether or not the allowable range is a blank, and, in the case of “Yes”, the process proceeds to Step sa05, and, in the case of “No”, the process proceeds to Step sa04.
[Step sa04] It is determined whether or not the command value is within the allowable range, and, in the case of “Yes”, the process ends, and, in the case of “No”, the process proceeds to Step sa05.
[Step sa05] An alarm stop request is made for the directed program analyzing unit, and the process ends.

FIG. 11 is a flowchart that illustrates the process of the interpolation axis command checking unit illustrated in FIG. 9. Hereinafter, each step will be described.

[Step sb01] Whether it is between the detection start command and the detection end command is determined, and, in the case of “Yes”, the process proceeds to Step sb02, and in the case of “No”, the process ends.
[Step sb02] It is determined whether or not the command is an interpolation command of the target axis, and, in the case of “Yes”, the process proceeds to Step sb03, and in the case of “No”, the process ends.
[Step sb03] It is determined whether or not the allowable range is a blank, and, in the case of “Yes”, the process proceeds to Step sb06, and, in the case of “No”, the process proceeds to Step sb04.
[Step sb04] An interpolation command ΔS of the target axis is added to S.
[Step sb05] It is determined whether or not S is within the allowable range, and, in the case of “Yes”, the process ends, and, in the case of “No”, the process proceeds to Step sa06.
[Step sb06] An alarm stop request is made for the interpolation command generating unit, and the process ends.

1. A numerical control device including a directed program analyzing unit for analyzing a directed program, and, an interpolation command generating unit for generating an interpolation command based on the analysis by the directed program analyzing unit, the numerical control device comprising:
an alarm axis designating unit configured to designate an axis that becomes a criterion for an alarm; and
an axis command checking unit configured to perform alarm stop in a case where, the axis designated by the alarm axis designating unit is directed or the interpolation command generating unit interpolates the axis designated by the alarm axis designating unit, as a result of the analysis of the directed program that is performed by the directed program analyzing unit.

2. The numerical control device according to claim 1, wherein the axis command checking unit belongs to the directed program analyzing unit, and the axis command checking unit is configured to, determine whether or not the axis designated by the alarm axis designating unit is directed in the directed program, determine whether or not an amount directed for the axis exceeds an allowable range set in advance, and perform alarm stop in a case where the directed amount exceeds the allowable range.

3. The numerical control device according to claim 1, wherein the axis command checking unit belongs to the interpolation command generating unit, and the axis command checking unit is configured to, determine whether or not the axis designated by the alarm axis designating unit is directed in the interpolation command, in a case where an erroneous axis direction is directed, determine whether or not a directed amount exceeds an allowable range set in advance, and, in a case where the directed amount exceeds the allowed range, perform alarm stop.

4. The numerical control device according to claim 1, wherein the axis command checking unit is configured to, determine whether or not the axis designated by the alarm axis designating unit is directed in the directed program analyzing unit and, in a case where the axis is directed, determine whether or not a directed amount exceeds an allowable range set in advance, and, in a case where the directed amount exceeds the allowed range, perform alarm stop, and further determine whether or not the axis designated by the alarm axis designating unit is directed in the interpolation command generating unit, and, in a case where the designated axis is directed, determines whether or not a directed amount exceeds an allowable range set in advance, and, in a case where the directed amount exceeds the allowed range, perform alarm stop.
